(19) United States
(12) Patent Application Publication
(10) Pub. No.: US 2003/0096637 A1
(43) Pub. Date: May 22, 2003

(54) Loop antenna formed of multiple concentric irregular loops

(76) Inventors: Walter John Keller III, Half Moon Bay, CA (US); Osbaldo Jose Romero, San Francisco, CA (US); Jesada Sivaraks, Pacifica, CA (US); Robert Paul Garcia, San Jose, CA (US)

Correspondence Address: FLIESLER DUBB MEYER & LOVEJOY, LLP, FOUR EMBARCADERO CENTER, SUITE 400, SAN FRANCISCO, CA, 94111, US

(21) Appl. No.: 10/014,314

(22) Filed: Nov. 9, 2001

(51) Int. Cl. H04B 1/44; H04B 1/38

(52) U.S. Cl. 455/562; 455/97; 455/83

(57) ABSTRACT

A multi-band compressed loop antenna is formed of multiple, directly and/or indirectly connected, compressed loops for use in a communication device to exchange energy over multiple frequency bands of operation. Each loop is formed by multiple and numerous segments arrayed in multiple diverse directions which forms a compressed loop so that the area of the antenna is decreased by combining such compressed loops. The multiple loops provide for resonances in multiple discrete frequency bands of operation. The multiple loops are arrayed in different configurations that include nested (concentric) and non-nested (non-concentric) loops as well as closely located and separated loops on the same or different layers of single or multi-layer structures.

### CROSS-REFERENCE TO RELATED APPLICATIONS

Title: ARRAYED-SEGMENT LOOP ANTENNA

Inventor: David Amundson Howard

Serial No.: U.S. Ser. No. 09/738,906

Filing Date: Dec. 14, 2000

Title: LOOP ANTENNA WITH RADIATION AND REFERENCE LOOPS

Inventors: Osbaldo Jose Romero; Walter John Keller, III; David Amundson Howard

Serial No. U.S. Ser. No. 09/815,928

Date Filed: Mar. 23, 2001

### BACKGROUND OF THE INVENTION

The present invention relates to the field of communication devices that communicate using radiation of electromagnetic energy and particularly relates to antennas and antenna connections for such communication devices, particularly for communication devices carried by persons or otherwise benefitting from small-sized antennas.

Communication Antennas Generally. In communication devices and other electronic devices, antennas are elements having the primary function of transferring energy to or from the electronic device through radiation. Energy is transferred from the electronic device into space or received from space into the electronic device. A transmitting antenna is a structure that forms a transition between guided waves contained within the electronic device and space waves traveling in space external to the electronic device. A receiving antenna is a structure that forms a transition between space waves traveling external to the electronic device and guided waves contained within the electronic device. Often the same antenna operates both to receive and transmit radiation energy.

J. D. Kraus “Electromagnetics”, 4th ed., McGraw-Hill, New York 1991, Chapter 15 Antennas and Radiation indicates that antennas are designed to radiate (or receive) energy. Antennas act as the transition between space and circuitry. They convert photons to electrons or vice versa. Regardless of antenna type, all involve the same basic principal that radiation is produced by accelerated (or decelerated) charge. The basic equation of radiation may be expressed as follows:

IL=Qν (Am/s)

where:

I=time changing current (A/s)

L=length of current element (m)

Q=charge (C)

ν=time-change of velocity which equals the acceleration of the charge (m/s)

The radiation is perpendicular to the direction of acceleration and the radiated power is proportional to the square of IL or Qν.

A radiated wave from or to an antenna is distributed in space in many spatial directions. The time it takes for the spatial wave to travel over a distance r into space between an antenna point, Pₐ, at the antenna and a space point, P, at a distance r from the antenna point is r/c seconds where r=distance (meters) and c=free space velocity of light (=3×10⁸ meters/sec). The quantity r/c is the propagation time for the radiation wave between the antenna point Pₐ and the space point Pₛ.

An analysis of the radiation at a point P at a time t, at a distance r caused by an electrical current I in any infinitesimally short segment at point Pₐ of an antenna is a function of the electrical current that occurred at an earlier time [t−r/c] in that short antenna segment. The time [t−r/c] is a retardation time that accounts for the time it takes to propagate a wave from the antenna point Pₐ at the antenna segment over the distance r to the space point P.

For simple antenna geometries, antennas are typically analyzed as a connection of infinitesimally short radiating antenna segments and the accumulated effect of radiation from the antenna as a whole is analyzed by accumulating the radiation effects of each antenna segment. The radiation at different distances from each antenna segment, such as at any space point Pₛ, is determined by accumulating the effects from each infinitesimally short antenna segment at point Pₐ of the antenna at the space point P. The analysis at each space point P is mathematically complex because the parameters for each segment of the antenna maybe different. For example, among other parameters, the frequency phase of the electrical current in each antenna segment and distance from each antenna segment to the space point P can be different.

A resonant frequency, f, of an antenna can have many different values as a function, for example, of dielectric constant of material surrounding antenna, the type of antenna and the speed of light.

In general, wave-length, λ, is given by λ=c/f=cT where c=velocity of light (=3×10⁸ meter/sec), f=frequency (cycles/sec), T=1/f=period (sec). Typically, the antenna dimensions such as antenna length, Aₗ, relate to the radiation wavelength λ of the antenna. The electrical impedance properties of an antenna are allocated between a radiation resistance, Rᵣ, and an ohmic resistance, Rₒ. The higher the ratio of the radiation resistance, Rᵣ, to the ohmic resistance, Rₒ the greater the radiation efficiency of the antenna.

Antennas are frequently analyzed with respect to the near field and the far field where the far field is at locations of space points P where the amplitude relationships of the fields approach a fixed relationship and the relative angular distribution of the field becomes independent of the distance from the antenna.

Antenna Types. A number of different antenna types are well known and include, for example, loop antennas, small loop antennas, dipole antennas, stub antennas, conical antennas, helical antennas and spiral antennas. Such antenna types have often been based on simple geometric shapes. For example, antenna designs have been based on lines, planes, circles, triangles, squares, ellipses, rectangles, hemispheres and paraboloids. The two most basic types of electromagnetic field radiators are the magnetic dipole and the electric dipole. Small antennas, including loop antennas, often have the property that radiation resistance, Rᵣ, of the antenna decreases sharply when the antenna length is shortened. Small loops and short dipoles typically exhibit radiation patterns of ½λ and ¼λ, respectively. Ohmic losses due to the ohmic resistance, Rₒ are minimized using impedance matching networks. Although impedance matched small circular loop antennas can exhibit 50% to 85% efficiencies, their bandwidths have been narrow, with very high Q, for example, Q>50. Q is often defined as (transmitted or received frequency)/(3 dB bandwidth).

An antenna goes into resonance where the impedance of the antenna is purely resistive and the reactive component goes to 0. Impedance is a complex number consisting of real resistance and imaginary reactance components. A matching network can be used to force resonance by eliminating the reactive component of impedance for a particular frequency.

Electric Dipole. A linear antenna is often considered as a large number of very short conductor elements connected in series. For purpose of explanation, the minimum element of linear antenna is a short electric dipole (see FIG. 8). The electric dipole is “short” in the sense that its physical length (L) is much smaller than the wavelength (λ) of the signal exciting it, that is, L/λ<<1. For purpose of analysis, the two ends of a electric dipole are considered plates that with capacitive loading. These plates and the L<<λ condition, provide a basis for assuming a uniform electric current I along the entire length of the electric dipole. Also, the electric dipole is assumed to be energized by a balanced transmission line, is assumed to have negligible radiation from the end plates, and is assumed to have a very thin diameter, d, that is, d<<L, such that the electric dipole consists simply of a thin conductor of length L carrying a uniform current I with point charges +q and −q at the ends. With such an assumed structure, the current I and charge q are related by:

$$\frac{ⅆ q}{ⅆ t} = I$$

For any point Pₐ on the electric dipole, the electric and magnetic fields at a point P a distance r from the point Pₐ as a result of the uniform electric current I through the element are represented as vector components in a spherical polar coordinate system having orthogonal XYZ axes (see FIG. 8 and FIG. 9.). For an electric dipole normal to the XY plane, the projection of the vector r in the XY-plane has an angle of φ with respect to the XZ plane and an angle of θ from the Z axis normal to the XY plane.

The general equation of both electric (Eᵣ, E_{θ}, E_{φ}) and magnetic (Hᵣ, H_{θ}, H_{φ}) components at point P, offset from point Pₐ by vector r, are as follows:

$${E}_{r} = \frac{[ I ] L cos θ}{2 πϵ} ( \frac{1}{c {r}^{2}} + \frac{1}{j ω {r}^{2}} )$$

$${E}_{θ} = \frac{[ I ] L sin θ}{2 π ϵ} ( \frac{j ω}{{c}^{2} r} + \frac{1}{c {r}^{2}} + \frac{1}{j ω {r}^{3}} )$$

$${H}_{φ} = \frac{[ I ] L sin θ}{4 π} ( \frac{j ω}{c r} + \frac{1}{{r}^{2}} )$$

where components E_{φ}, Hᵣ, H_{θ} are zero for every P and

where:

[I]=Iₒe^{jω(t-r/c)}

Iₒ=Peak value in time of current (uniform along dipole)

c=Velocity of light

L=Length of dipole

r=Distance from dipole to observation point

Considering the above equations, the 1/r² term is called the induction field or intermediate field component and the 1/r³ term represents the electrostatic field or near field component. These two terms are significant only very close to the dipole and therefore are considered in the near field region of the antenna. For very large r, the 1/r² and 1/r³ terms can be neglected leaving only the 1/r term as being significant. This 1/r terms is called the far field. Consequently, the revised equations of electric and magnetic components at the far field are given as:

Eᵣ=0

$${E}_{θ} = \frac{j 60 π [ I ] sin θ}{r} \frac{L}{λ}$$

$${H}_{φ} = \frac{j [ I ] sin θ}{2 r} \frac{L}{λ}$$

Examining the E_{θ} and H_{φ} components in the far field, it can be seen that E_{θ} and H_{φ} are in time phase (with respect to each other) in the far field, and that the field patterns of both are proportional to sin(θ) but independent of φ. The space patterns of those fields are a figure of revolution and doughnut-shaped in three dimensions (see FIG. 12) figure-8 shaped in two dimensions (see FIG. 13). Note that the near field patterns for E_{θ} and H_{φ} are proportional to only sin(θ); so, the shapes of the near field patterns are the same as for the far field and that the Eᵣ component in the near field is proportional to cosθ.

Magnetic Dipole. A magnetic dipole is the dual of the electric dipole and hence an analogy to the electric dipole can be used for purpose of analysis. A magnetic dipole is a short circular antenna element arrayed to form a magnetic field and is represented by a very short loop (see FIG. 10) in the XY-plane. For purpose of analysis, the magnetic dipole conducts an electric current I that causes a magnetic current (Iₘ) normal to the plane of the magnetic dipole. The magnetic current (Iₘ) of the magnetic dipole is the dual of the electric current (I) of the electric dipole. The analysis of the far field pattern of a magnetic dipole (see FIG. 10) is similar to the analysis of the far field pattern of the electric dipole. The only difference is that the electric current I is replaced by a magnetic current Iₘ and the electric field is replaced by magnetic field.

For purpose of analysis, the magnetic dipole is a small loop of area A carrying a uniform in-phase electric current I which is the dual of the electric dipole of length L in the far field. The fields of the short magnetic dipole are the same as the fields of a short electric dipole with the E and H fields and I and Iₘ currents interchanged as follows:

| Small Electric Dipole | Small Magnetic Dipole |
|---|---|
| ${E}_{θ} = \frac{j60 π [ I ] sin θ}{r} \frac{L}{λ}$ | ${H}_{θ} = \frac{j [ {I}_{m} ] sin θ}{240 πr} \frac{L}{λ}$ |
| ${H}_{φ} = \frac{j [ I ] sin θ}{2 r} \frac{L}{λ}$ | ${E}_{φ} = \frac{j [ {I}_{m} ] sin θ}{2 r} \frac{L}{λ}$ |

$where [ {I}_{m} ] = {I}_{m0} {ⅇ}^{jω ( t - r / c )}$

Considering the equation of far field pattern for magnetic dipole, both H_{θ} and E_{φ} are proportional to sin(θ) but independent of φ. Consequently, the far field pattern of the H_{θ} and E_{φ} components of a magnetic dipole are doughnut-shaped in three dimensions (see FIG. 12) and figure-8 circular in cross section (see FIG. 13).

Applying Relationship Between a Loop and Magnetic Dipole. The relationship between the length of magnetic dipole and a small loop antenna are used to derive the far field pattern equation of a small loop antenna. Accordingly, [Iₘ]L=−j240[I] is used in the above far-field equation for a small magnetic dipole and the far field equations of a small loop antenna are written as:

$${E}_{φ} = \frac{120 {π}^{2} [ I ] sin θ}{r} \frac{A}{{λ}^{2}}$$

$${H}_{φ} = \frac{[ I ] sin θ}{r} \frac{A}{{λ}^{2}}$$

where

[I]=Iₒe^{jω(t-r/c)}

Iₒ=Peak value in time of current (uniform along dipole)

c=Velocity of light

A=Area of loop antenna

r=Distance from Loop to observation point

The above far field equations are good approximations for loops up to 0.1 wavelength in diameter and dipoles up to 0.1 wavelength long. A comparison of far fields between small electric dipoles and small loop antennas are given in the following table:

| Field | Electric dipole | Loop Antenna |
|---|---|---|
| Electric component | ${E}_{θ} = \frac{j60 π [ I ] sin θ}{r} \frac{L}{λ}$ | ${E}_{θ} = \frac{120 {π}^{2} [ I ] sin θ}{r} \frac{A}{{λ}^{2}}$ |
| Magnetic component | ${H}_{φ} = \frac{j [ I ] sin θ}{2 r} \frac{L}{λ}$ | ${H}_{φ} = \frac{[ I ] sin θ}{r} \frac{A}{{λ}^{2}}$ |

From the table, the presence of the operator j in the dipole expressions and its absence in the loop equations indicate that the fields of the electric dipole and of the loop are in time phase quadrature. This quadrature relationship is a fundamental difference between the fields of pure magnetic dipoles (circular loops) and electric dipoles (linear elements).

The analytical models for showing the fields of antennas that are larger than short dipoles are mathematically complex even when the antennas have a high degree of symmetry. Even more difficulty of analysis arises when antennas have irregular shapes and require operations over multiple bands or with high bandwidth.

In the mobile communications environment, antennas are frequently placed inside the case of the communication device in close proximity to conductive components. In such close proximity, the antenna near and intermediate fields become significant and cannot be neglected to determine far field radiation patterns. For these reasons, the analytical models for short dipoles do not adequately predict the behavior of antennas needed for new communication devices. Fundamentally new designs and design techniques are needed to address the new environment of personal communication devices.

Personal communication devices, when in use, are usually located close to an ear or other part of the human body. Accordingly, use of personal communication devices subjects the human body to radiation. The radiation absorption from a personal communication device is measured by the rate of energy absorbed per unit body mass and this measure is known as the specific absorption rate (SAR). Antennas for personal communication devices are designed to have low peak SAR values so as to avoid absorption of unacceptable levels of energy, and the resultant localized heating by the body.

For personal communication devices, the human body is located in the near-field of an antenna where much of the electromagnetic energy is reactive and electrostatic rather than radiated. Consequently, it is believed that the dominant cause of high SAR for personal communication devices is from reactance and electric field energy of the near field. Accordingly, the reactance and electrostatic fields of personal communication devices need to be controlled to minimize SAR. Regardless of the reasons, low SAR is a desirable parameter along with the other important parameters for antennas in communication devices.

In consideration of the above background, there is a need for improved antennas suitable for personal communication devices and other devices needing small and compact antennas.

### SUMMARY

The present invention is a compressed loop antenna formed of multiple loops for radiation. The loop antenna operates in a communication device to exchange energy over multiple bands of radiation frequencies and includes a connection element having first and second conductors for conduction of electrical current in the radiation loops.

Each loop is formed of radiation segments electrically connected in series between first and second connection points for exchange of energy at a band of radiation frequencies. The segments are arrayed in multiple diverse directions so that the area of the antenna loop is compressed. The pattern formed by the antenna segments may be regular and repeating or may be irregular and non-repeating. Each loop has an electrical length, Aₗ that is proportional to the sum of segment lengths for that loop. Collectively the arrayed segments appreciable increase antenna electrical lengths while permitting the antenna to be compressed to fit within the available areas of communication devices.

The multiple loops provide multiple frequency bands of operation for the antenna. The multiple loops are arrayed in different configurations that include concentric and non-concentric loops as well as closely located and separated loops. The loops are constructed from multi-layer materials that include a non-conductive substrate and one or more conducting layers.

The multiple loops are connected in common to the connection element, either directly by electrical connection and/or by capacitive coupling.

The arrayed-segment loop antennas are typically located internal to the housings of personal communicating devices where they tend to be susceptible to de-tuning due to objects in the near field in close proximity to the personal communicating devices. The multi-loop antenna with multiple layers providing mirroring and reference planes tends to increase the immunity to de-tuning.

The foregoing and other objects, features and advantages of the invention will be apparent from the following detailed description in conjunction with the drawings.

### BRIEF DESCRIPTION OF THE DRAWINGS

FIG. 1 depicts a wireless communication device showing by broken line the location of an antenna area with a compressed antenna.

FIG. 2 depicts a schematic, cross-sectional end view of the FIG. 1 communication device.

FIG. 3 depicts a perspective view of a multi-loop antenna used in the communication device of FIG. 1 and FIG. 2.

FIG. 4 depicts a cross-sectional view of one compressed antenna element of the multi-loop antenna of FIG. 3.

FIG. 5 depicts components of the communication device of FIG. 1 including a connection element between an antenna and a transceiver unit.

FIG. 6 depicts a front view of the connection element of FIG. 5.

FIG. 7 depicts a section view of a conducting tang taken along the section line 7-7′ of FIG. 6.

FIG. 8 depicts a short electric dipole element antenna.

FIG. 9 depicts a three-dimensional representation of the fields of the short dipole element of FIG. 8.

FIG. 10 depicts a short loop element that is an analytical tool similar to the short electric dipole element of FIG. 8.

FIG. 11 depicts a three-dimensional representation of the fields of the short loop element of FIG. 10.

FIG. 12 depicts a three-dimensional representation of the E_{θ} and H_{φ} fields of the short dipole element of FIG. 8 and short loop element and FIG. 10.

FIG. 13 depicts a two-dimensional representation of the E_{θ} and H_{φ} fields of the short dipole element of FIG. 8 and short loop element and FIG. 10.

FIG. 14 depicts a top view of a multilayer antenna structure including compressed loops on a substrate.

FIG. 15 depicts a front view of the antenna structure of FIG. 14.

FIG. 16 depicts a top view of the top layer the antenna structure of FIG. 14.

FIG. 17 depicts a top view of the bottom layer the antenna structure of FIG. 14.

FIG. 18 depicts a two-dimensional representation of the field pattern of the antenna structure of FIG. 14 for the GSM 900 MHz, GSM 1800 MHz and PCS 1900 MHz frequency bands.

FIG. 19 depicts a top view of an alternate connection element of FIG. 5.

FIG. 20 depicts a front view of the alternate connection element of FIG. 5 and FIG. 19.

FIG. 21 depicts an end view of the alternate connection element of element of FIG. 5 and FIG. 19.

FIG. 22 depicts an isometric view of the alternate connection element of element of FIG. 5 and FIG. 19.

### DETAILED DESCRIPTION

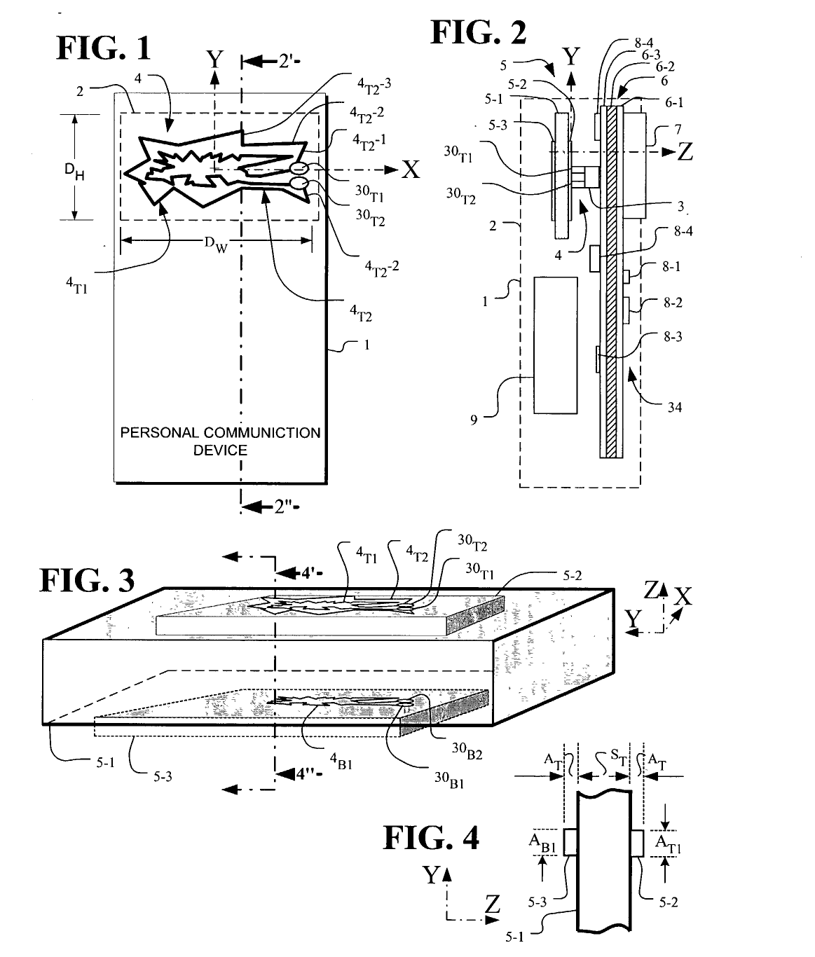

In FIG. 1, personal communication device 1 is a cell phone, pager or other similar communication device that can be used in close proximity to people. The communication device 1 includes an antenna area 2 for receiving an antenna 4 which receives and/or transmits radio wave radiation from and to the personal communication device 1. In FIG. 1, the antenna area 2 has a width D_{W} and a height D_{H}. A section line 2′-2″ extends from top to bottom of the personal communication device 1.

In FIG. 1, the antenna 4 is a multi-loop antenna that includes a first compressed radiation loop 4_{T1} generally surrounded by a second compressed radiation loop 4_{T2}. The loops 4_{T1} and 4_{T2} are connected in common at each end by connection pads 30_{T1} and 30_{T2}. The loops 4_{T1} and 4_{T2} generally lie in the XY-plane and have magnetic current in the Z-axis direction normal to the XY-plane.

In FIG. 1, antenna 4_{T2} has a plurality of electrically conducting radiation segments 4_{T2}-1, 4_{T2}-2, 4_{T2}-3, . . . , 4_{T2}-n, . . . , 4_{T2}-N each having a segment length. The segments 4_{T2}-1, 4_{T2}-2, 4_{T2}-3, . . . , 4_{T2}-n, . . . , 4_{T2}-N are connected in series to form a loop electrically connected between the first and second conductor pads 30_{T1} and 30_{T2}. The loop 4_{T2} has an electrical length, A_{l,T2}, that is proportional to the sum of segment lengths for each of the radiation segments 4_{T2}-1, 4_{T2}-2, 4_{T2}-3, . . . , 4_{T2}-n, . . . , 4_{T2}-N so as to facilitate an exchange of energy at radiation frequencies for loop 4_{T2}. Similarly, the loop 4_{T1} has an electrical length, A_{l,T1}, that is proportional to the sum of segment lengths for each of the radiation segments so as to facilitate an exchange of energy at radiation frequencies for antenna 4_{T1}.

In FIG. 1, antenna 4 has each of the loops 4_{T1} and 4_{T2} formed of straight-line segments arrayed in an irregular compressed pattern and connected electrically in series to form a loop antenna. The straight-line segments of the antenna 4_{T2}, for example, fit within the antenna area 2, which has been allocated for an antenna in the communication device 1 of FIG. 1. The antenna 4_{T2} has an actual enclosed area, Aₐᵣₑₐ, that can be represented by an imaginary circle of radius R₁ so that Aₐᵣₑₐ=π(R₁)² and the imaginary circle has a circumference of π(2R₁). The antenna 4_{T2} has an electrical length, A_{l,T2} which if stretched into a circle would have a circumference of π(2R₂) where π(2R₂) is significantly longer than the circumference π(2R₁) of the imaginary circle representing the area enclosed by antenna 4_{T2}.

In FIG. 1, antenna 4 has each of the loops 4_{T1} and 4_{T2} formed of straight-line segments arrayed in multiple divergent directions not parallel to the XY orthogonal coordinate system so as to provide an long antenna electrical length while permitting the overall outside dimensions, D_{H} by D_{W}, of said loop to fit within the antenna area 2 of said communication device.

The FIG. 1 antenna 4, including antenna elements 4_{T1} and 4_{T2}, is used for communication with the wavelengths, λ_{T1} and λ_{T2}, for one or more of the respective resonant frequencies of interest. The wavelengths, λ_{T1} and λ_{T2}, of the respective resonant frequencies of interest are such that, for efficient antenna design, the electrical lengths, A_{lT1} and A_{lT2}, cannot be made small with respect to λ_{T1} and λ_{T2}. For this reason, it cannot be assumed that the simple analytical models used to describe loop antennas and electric dipole antennas apply without limitation. Rather, the analytical models are mathematically complex, not easily describable if describable at all.

In FIG. 2, the personal communication device 1 of FIG. 1 is shown in a schematic, cross-sectional, end view taken along the section line 2′-2″ of FIG. 1. In FIG. 2, a circuit board 6 includes, by way of example, one conducting layer 6-1, an insulating (dielectric) layer 6-2 and another conducting layer 6-3. The printed circuit board 6 supports the electronic components associated with the communication device 1 including a display 7 and miscellaneous components 8-1, 8-2, 8-3 and 8-4 which are shown as typical. Communication device 1 also includes a battery 9. The antenna assembly 5 includes a substrate 5-1 and a conductive layer 5-2 that forms a loop antenna 4 offset from the printed circuit board 6 by a gap which tends to reduce coupling between the antenna 5-2 and the printed circuit board 6. The conductive layer 5-2 is connected to printed circuit board 6 by a connection element 3. In the embodiment shown in FIG. 1 and FIG. 2, the connection element 3 includes, for example, two tangs that are spring-loaded against the two connection pads 30_{T1} and 30_{T2}. The two tangs have a balanced spring compression for making electrical connection to the two connection pads 30_{T1} and 30_{T2} that function as first and second conductors for conducting electrical current through the antenna. The antenna 4 of FIG. 1 and FIG. 2 is a compressed antenna that has small area so as to fit within the antenna area 2. Also, the antenna 4 hat has acceptably low SAR and otherwise exhibits good performance in transmitting and receiving signals.

FIG. 3 depicts a perspective view of a multi-loop antenna 4 in the communication device of FIG. 1 and FIG. 2. In FIG. 3, the multi-loop antenna 4 of FIG. 1 includes, in addition to the first compressed loop 4_{T1} and the second compressed loop 4_{T2}, a third compressed loop 4_{B1}. The third compressed loop 4_{B1} appears on layer 5-3 on the opposite side of substrate layer 5-1 as layer 5-2. The third compressed loop 4_{B1} connects at each end to connection pads 30_{B1} and 30_{B2}. For purposes of the FIG. 3 embodiment, the third compressed loop 4_{B1} is substantially the same size and shape as the first compressed loop 4_{T1} and is juxtaposed the the first compressed loop 4_{T1} as offset in the Z-axis direction. The loops 4_{T1}, 4_{T2} and 4_{B1}, therefore, all generally lie in or parallel to the XY-plane and have magnetic current in the Z-axis direction normal to the XY-plane.

In FIG. 3, the third compressed loop 4_{B1} connects at connection pads 30_{B1} and 30_{B2} on layer 5-3 which are offset from the pads 30_{T1} and 30_{T2} on layer 5-2. In the embodiment of FIG. 3, connection pads 30_{B1} and 30_{B2} capacitively couple the pads 30_{T1} and 30_{T2} whereby the compressed loops 4_{T1}, 4_{T2} and 4_{B1} all are connected in common and are connected through the connection element 3 to the transceiver on circuit board 6 of FIG. 2. The capacitive coupling of connection pads 30_{B1} and 30_{B2} to the pads 30_{T1} and 30_{T2} is a form of indirect connection in that a direct electrical wired connection is not required. In alternative embodiments, through-layer conductors (vias) or other equivalent means are employed to interconnect the compressed loops 4_{T1}, 4_{T2} and 4_{B1} thereby forming a direct electrical wired connection. In still other alternative embodiments, any two or more of the compressed loops 4_{T1}, 4_{T2} and 4_{B1} can connect independently through one ore more connection elements to the transceiver on circuit board 6 of FIG. 2. In further embodiments, the compressed loops of a multi-loop antenna, with any number of loops such as two, three four or more, are located on the same circuit board 6 or multiple ones of other boards like board 5.

In FIG. 4, a schematic sectional view along the section line 4′-4″ of FIG. 4 is shown. In the example of FIG. 4, the thickness, S_{T}, of the dielectric substrate 5-1 is approximately 0.08 mm. The width, A_{Wr}, of a segment 4_{T1}-n of antenna loop 4_{T1} in lawyer 5-2 is approximately 1.8 mm and the thickness, A_{T}, of the segment 4_{T1}-n is approximately 1.8 mm. The width, A_{Wa}, of a segment 4_{T2}-n of antenna loop 4_{T1} in lawyer 5-2 is approximately 1.8 mm and the thickness, A_{T}, of the segment 4_{T2}-n is approximately 0.02 mm. The antenna material of FIG. 4 in one embodiment is Kapton Polyimide with a copper thickness 1 oz. double size on a 3 mil board.

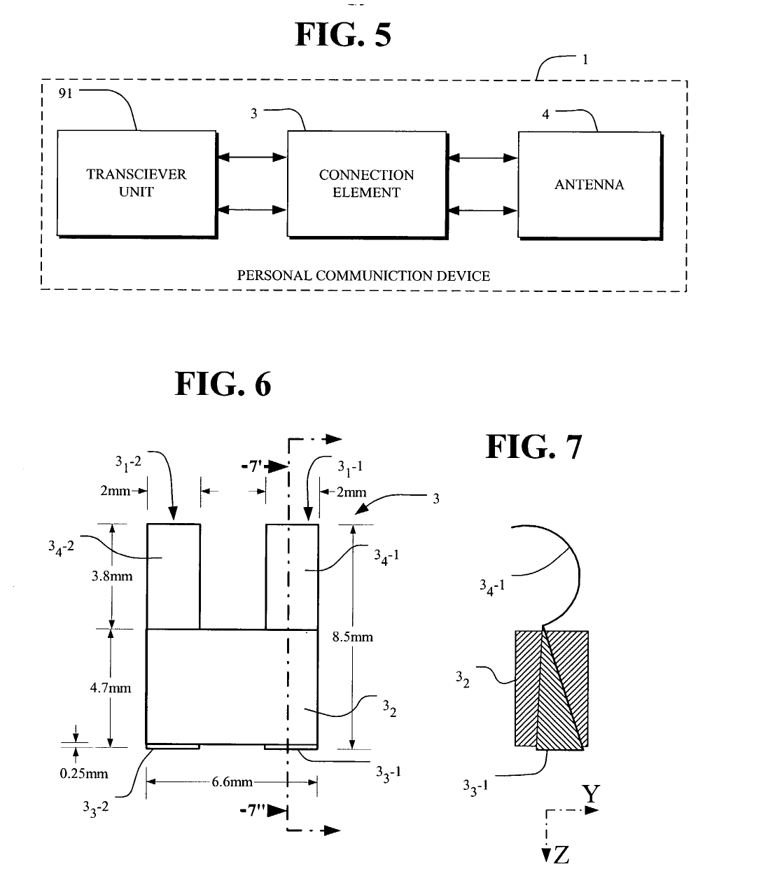

FIG. 5 depicts the major components that form the communication device 1 of FIG. 1. In particular, the transceiver unit 91 is formed by one or more of the components 8 mounted on the circuit board 6 of FIG. 2. The connection element 3 connects the transceiver unit 91 to the antenna 4.

FIG. 6 depicts one embodiment of a connection element 3 of FIG. 5 that connects the transceiver unit 91 to the antenna 4. The connection element 3 includes connection tangs 3₁, including tang 3₁-1 and tang 3₁-2, that are held in parallel relationship by rigid plastic base 3₂. Each of the tangs 3₁ is about 8.5 mm high by about 2 mm wide. The plastic base 3₂ is about 6.6 mm by 4.7 mm. The bottoms 3₃-1 and tang 3₃-2 of the tangs 3₁-1 and 3₁-2 extend below the plastic base 3₂ so as to facilitate electrical connection to board 6 of FIG. 1 by solder or other conventional means. The tops 3₄-1 and 3₄-2 of the tangs 3₁-1 and 3₁-2 extend about 3.8 mm above the plastic base 3₂ and are constructed of a good conductor material, such as Beryllium copper to provide a spring force for making electrical connection to the pads 30_{T1} and 30_{T2} of antenna 4 in FIG. 1.

FIG. 7 depicts a section view of conducting tang 3₁-1 taken along the section line 7-7′ of FIG. 6. The top 3₄-1 of the tang 3₁-1 extends in a circular arc about 3.8 mm above the plastic base 3₂ to provide a spring force for making electrical connection to the pads 30₁ of antenna 4 in FIG. 1.

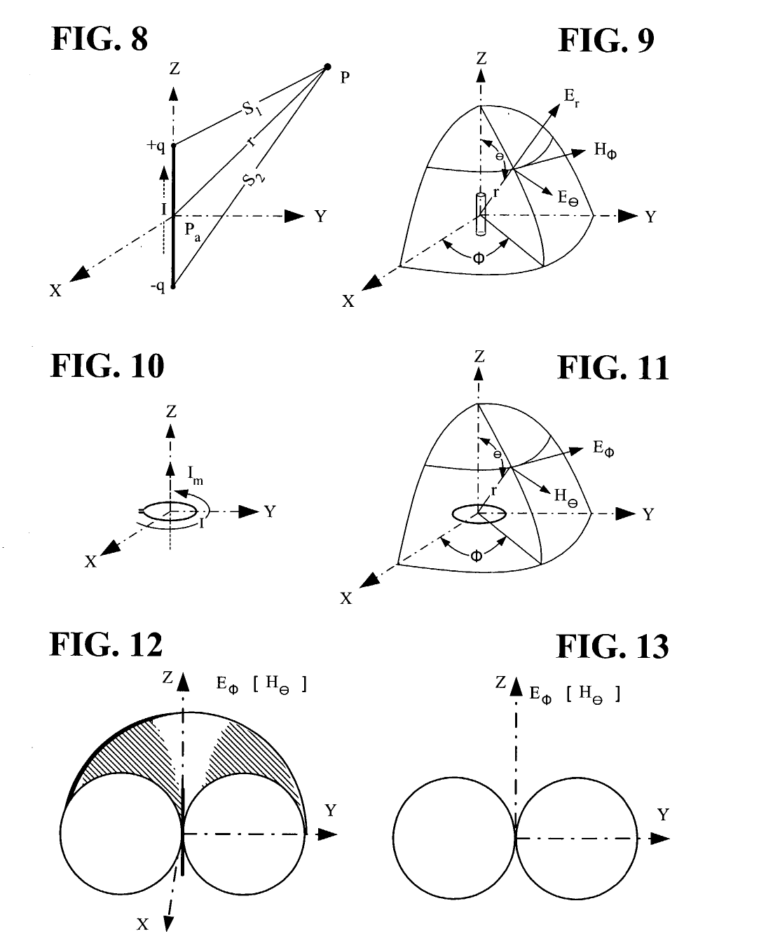

FIG. 8 depicts a short dipole element of an antenna and conceptually represents any short section of antenna 4 of FIG. 1 or an equivalent short dipole element which, for purposes of explanation, is assumed normal to the XY-plane of antenna 4.

FIG. 9 depicts a three-dimensional representation of the fields of the short dipole element of FIG. 8. As discussed above, the equations of electric and magnetic components of the electric dipole at the far field are given as:

Eᵣ=0

$${E}_{θ} = \frac{j 60 π [ I ] sin θ}{r} \frac{L}{λ}$$

$${H}_{φ} = \frac{j [ I ] sin θ}{2 r} \frac{L}{λ}$$

When the entire antenna of FIG. 1 is compressed to the limit where all points of the loop are spaced infinitesimally close together in the X and Y dimensions, but not compressed in the Z direction, an electric dipole like that shown in FIG. 8 results that represents the accumulation of far field equations of the form provided above. Examining the E_{θ} and H_{φ} components in the far field, it can be seen that E_{θ} and H_{φ} are in time phase (with respect to each other) in the far field, and that the field patterns of both are proportional to sin(θ) but independent of φ. The space patterns of those fields are a figure of revolution and doughnut-shaped in three dimensions (see FIG. 12) figure-8 shaped in two dimensions (see FIG. 13).

FIG. 10 depicts a short loop element arrayed in the XY plan and is the limiting case where each infinitesimal point of the antenna 4 in FIG. 1 is spaced as far as possible from every other point on the loop without breaking the loop. The magnetic dipole conducts an electric current I that causes a magnetic current (Iₘ) normal to the XY-plane of the magnetic dipole. The analysis of the far field pattern of a magnetic dipole (see FIG. 10) is similar to the analysis of the far field pattern of the electric dipole. The only difference is that the electric current I is replaced by a magnetic current Iₘ and the electric field is replaced by magnetic field.

FIG. 11 depicts a three-dimensional representation of the fields of the short loop element of FIG. 10. The fields of the short magnetic dipole are the same as the fields of a short electric dipole with the E and H fields and I and Iₘ currents interchanged as follows:

| Small Electric Dipole | Small Magnetic Dipole |
|---|---|
| ${E}_{θ} = \frac{j60 π [ I ] sin θ}{r} \frac{L}{λ}$ | ${H}_{θ} = \frac{j [ {I}_{m} ] sin θ}{240 πr} \frac{L}{λ}$ |
| ${H}_{φ} = \frac{j [ I ] sin θ}{2 r} \frac{L}{λ}$ | ${E}_{φ} = \frac{j [ {I}_{m} ] sin θ}{2 r} \frac{L}{λ}$ |

$where [ {I}_{m} ] = {I}_{m0} {ⅇ}^{jω ( t - r / c )}$

Considering the equation of far field pattern for magnetic dipole, both H_{θ} and E_{φ} are proportional to sin(θ) but independent of φ. Consequently, the far field pattern of the H_{θ} and E_{φ} components of a magnetic dipole are doughnut-shaped in three dimensions (see FIG. 12) and figure-8 circular in cross section (see FIG. 13).

FIG. 12 depicts a three-dimensional representation of the E_{θ} and H_{φ} fields of the short dipole element of FIG. 8 and short loop element and FIG. 10.

FIG. 13 depicts a two-dimensional representation of the E_{θ} and H_{φ} fields of the short dipole element of FIG. 8 and short loop element and FIG. 10.

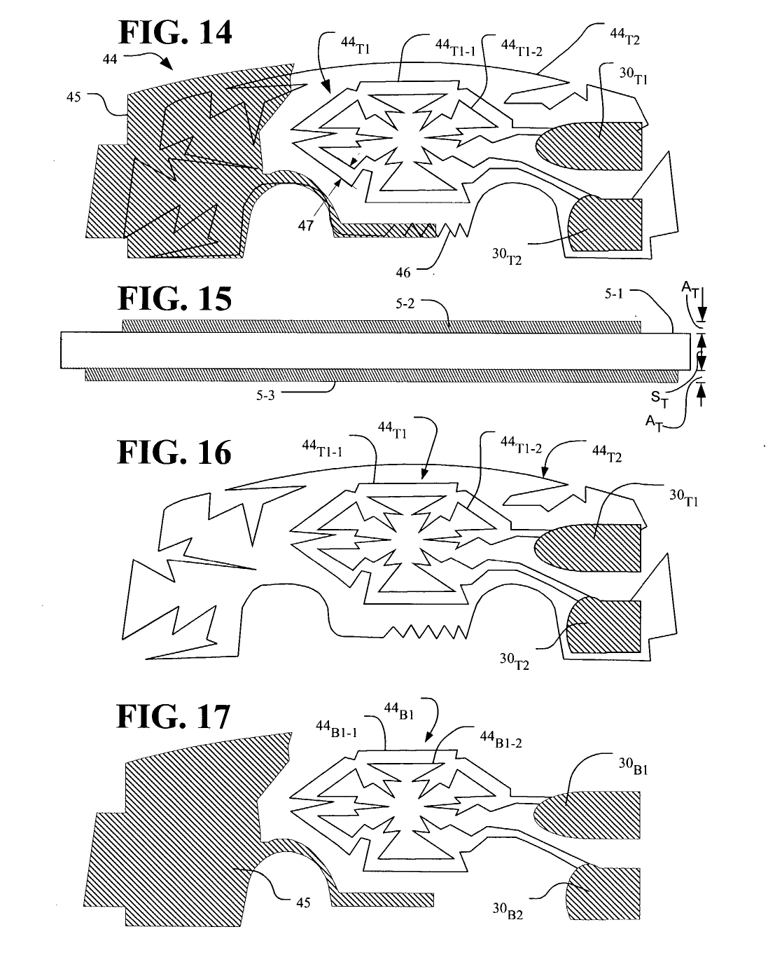

FIG. 14 depicts a top view of a multi-loop antenna 44 that includes a first compressed loop 44_{T1} generally surrounded by a second compressed loop 44_{T2}. The loops 44_{T1} and 44_{T2} are connected in common at each end by connection pads 30_{T1} and 30_{T2}. The loops 44_{T1} and 44_{T2} generally lie in the XY-plane and have magnetic current in the Z-axis direction normal to the XY-plane. The loop 44_{T1} is formed of two concentric loops, namely, sub-loops 44_{T1-1} and 44_{T1-2}, where sub-loop 44_{T1-2} is nested within sub-loop 44_{T1-1}.

To achieve the wide bandwidth for the GSM1800 and PCS1900 frequency bands, the loop 44_{T1} uses two sub-loops 44_{T1-1} and 44_{T1-2} with two resonant frequencies, λ_{T1-1} and λ_{T1-2}, that are close to each other. In the embodiment described, the electrical length of sub-loop 44_{T1-1} is approximately 55.1 mm and the sub-loop fits within a rectangle of approximate height 9.4 mm and width 19.5 mm and the electrical length of sub-loop 44_{T1-2} is approximately 99.9 mm and the sub-loop 44_{T1-2} fits within a rectangle of approximate height 7.4 mm and width 18 mm.

In FIG. 14, the multi-loop antenna 44 includes the compressed loop 44_{T2} which provides the GSM800 capabilities for antenna 44. The loop 44_{T2} is connected in common to the loop 44_{T1} at each end by connection pads 30_{T1} and 30_{T2}. The loops 44_{T1}, including sub-loops 44_{T1-1} an 44_{T1-2}, and 44_{T2} generally lie in the XY-plane and have magnetic current in the Z-axis direction normal to the XY-plane.

The loop 44_{T2} includes the segments 46 that meander in a short close pattern. The lengths of the segments 46 are easily varied without changing the principal shape of the overall array of segments that form loop 44_{T2}. The segments 46 are “tuning” segments that are modified in length to permit tuning of the antenna 44. Variations in antenna size and other physical parameters can result from variations in the manufacturing steps inherent in processing single and double-sided substrates and other multilayer structures with multiple layers to form antennas and hence tuning features of the antenna 44 are important in achieving the desired antenna performance over all bands of interest. In addition to the segments 46, the size and location of the pads 30 can be easily adjusted for tuning.

FIG. 15 depicts a front view of the antenna structure of FIG. 14. In FIG. 15, an antenna layer 5-2 is on top of the substrate 5-1 and an antenna layer 5-3 is below the substrate layer 5-1. The thickness, S_{T}, of the dielectric substrate 5-1 is approximately 0.08 mm and the thickness, A_{T}, of the layers 5-2 and 5-3 is approximately 1.8 mm.

FIG. 16 depicts a top view of the top layer 5-2 of the antenna structure of FIG. 14. The multi-loop antenna 44 includes the first compressed loop 44_{T1} surrounded by a second compressed loop 44_{T2}. The loop 44_{T1} includes sub-loop 44_{T1-1} and sub-loop 44_{T1-2} that are spaced apart on an average by approximately 0.02 mm and are connected in common with the ends of loop 44_{T2} at each end by connection pads 30_{T1} and 30_{T2}. The loops 44_{T1} and 44_{T2} generally lie in the XY-plane and have magnetic current in the Z-axis direction normal to the XY-plane.

FIG. 17 depicts a top view of the bottom layer 5-3 of the antenna 44 of FIG. 14. The layer 5-3 portion of the multi-loop antenna 44 includes the first compressed loop 44_{B1-1} surrounded by a second compressed loop 44_{B1-2}. The loops 44_{B1-1} and 44_{B1-2} on layer 5-3 are on the opposite side of substrate layer 5-1 as layer 5-2 and are juxtaposed and have the same size and shape as the loops 44_{T1-1} and 44_{T1-2} of layer 5-2 and hence loops 44_{B1-1} and 44_{B1-2} are “mirror images” of the loops 44_{T1-1} and 44_{T1-2}. The loops 44_{B1-1} and 44_{B2-2} connect at each end to connection pads 30_{B1} and 30_{B2}. The loops 44_{B1-1} and 44_{B2-2} generally lie in or parallel to the XY-plane and have magnetic current in the Z-axis direction normal to the XY-plane. The layer 5-3 also includes a conductive region 45 that serves as a ground or parasitic patch for the antenna 44.

In the embodiment of FIG. 14 through FIG. 17, connection pads 30_{B1} and 30_{B2} capacitively couple the pads 30_{T1} and 30_{T2} whereby the compressed loops 44_{T1}, 44_{T2} and 44_{B1} all are connected in common and are connected through the connection element 3 to the transceiver on circuit board 6 of FIG. 2. In alternative embodiments, through-layer conductors or other equivalent means are employed to interconnect the compressed loops 44_{T1}, 44_{T2} and 44_{B1}. In still other alternative embodiments, any two or more of the compressed loops 44_{T1}, 44_{T2} and 44_{B1} can connect independently through one ore more connection elements to the transceiver on circuit board 6 of FIG. 2. In other embodiments, the compressed loops of a multi-loop antenna, with any number of loops such as two, three four or more, are located on the same circuit board 6 or multiple ones of other boards like board 5 having single, double or more layers.

In the embodiment of FIG. 14 through FIG. 17, the dimensions of the compressed loops 44_{T1}, 44_{T2} and 44_{B1}, including the sub-loops 44_{T1-1} and 44_{T1-2} and the sub-loops 44_{B1-1} and 44_{B1-2}, including line traces (see A_{T} and A_{B1} and A_{T1} in FIG. 4, for example) and the overall lengths of the compressed loops determine the desired resonant frequencies for the antenna 44. The dimensions of the antenna loops and the dimensions of the connection element 3 of FIG. 5, particularly of the tangs 3₁-1 and 3₁-2, combine to obtain resistance close to 50 ohms for a perfect Voltage Standing Wave Ratio (VSWR) and for strong radiation over the entire bandwidth of the antenna 44.

In the embodiment of FIG. 14 through FIG. 17, the design of the tangs 3₁-1 and 3₁-2 ensures strong mechanical properties with the necessary height for connection to circuit board 6 in FIG. 2. Since current tends to be divided (“Current Divider Rule”) in each of the loops of antenna 44 in proportion to the loop impedance of each loop, the impedance in each loop is established the same and near 50 ohms. The use of common feeding points through pads 30_{T1} and 30_{T2} for the antenna 44 for all the sub-loops is a simple design that insures balanced connection over all the frequency ranges.

The multi-loop antenna 44 has an offset 47 between the sub-loops 44_{T1-1} and 44_{T1-2} and between the sub-loops 44_{B1-1} and 44_{B1-2}, that has been selected for good performance. A larger offset between the sub-loops may displace the resonant frequencies that are combined for obtaining wider bandwidth. A smaller offset between the sub-loops may result in a poorer radiation pattern.

In summary, the FIG. 14 through FIG. 17 embodiment of a multi-loop antenna provides a triband multi-band antenna with the following specifications.

| | |
|---|---|
| | Frequency Range |
| GSM 900 | 880-960 MHz |
| European PCS 1800 | 1710-1880 MHz |
| US PCS 1900 | 1850-1990 MHz |
| | VSWR |
| GSM (Tx Bandwidth) | less than 3.0:1 |
| European PCS (Tx Bandwidth) | less than 2.5:1 |
| US PCS (Tx Bandwidth) | less than 2.5:1 |

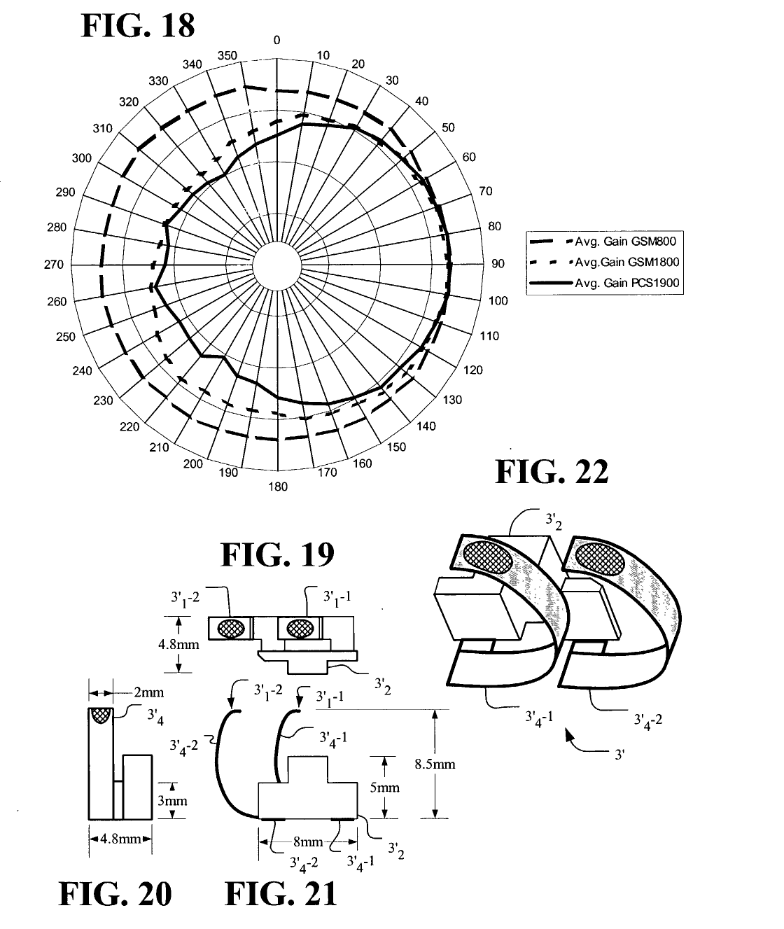

FIG. 18 depicts a two-dimensional representation of the field pattern of the antenna structure of FIG. 14 for the GSM 900 MHz, European PCS 1800 MHz and US PCS 1900 MHz frequency bands.

FIG. 19, FIG. 20, FIG. 21 and FIG. 22 depict top, front, end and isometric views, respectively, of an alternate connection element 3 of FIG. 5 that connects the transceiver unit 91 to the antenna 4. The connection element 3 includes connection tangs 3′₁, including tang 3′₁-1 and tang 3′₁-2, that are held in linear relationship by rigid plastic base 3′₂. Each of the tangs 3′₁ is about 8.5 mm high by about 2 mm wide. The plastic base 3′₂ is about 8 mm wide, 4.8 mm deep and 5 mm high. The bottoms 3′₃-1 and tang 3′₃-2 of the tangs 3′₁-1 and 3′₁-2 extend below the plastic base 3₂ so as to facilitate electrical connection to board 6 of FIG. 1 by solder or other conventional means. The tops 3′₄-1 and 3′₄-2 of the tangs 3′₁-1 and 3′₁-2 extend about 8.5 mm above the bottom of plastic base 3′₂ and are constructed of a good conductor material, such as Beryllium copper to provide a spring force for making electrical connection to the pads 30_{T1} and 30_{T2} of antenna 4 in FIG. 1 or pads 30_{T1} and 30_{T2} of antenna 44 in FIG. 14.

While the invention has been particularly shown and described with reference to preferred embodiments thereof it will be understood by those skilled in the art that various changes in form and details may be made therein without departing from the scope of the invention.

1. (Original) A multiband loop antenna, for use with a communication device, operating for exchanging energy in bands of radiation frequencies, comprising,
connection means having first and second conductors for conduction of electrical current,
two or more radiation loops wherein,
each loop includes a plurality of electrically conducting segments, each segment having a segment length, where the segments are electrically connected in series between said first and second conductors for exchange of energy in a band of said radiation frequencies, said loop having an electrical length, Aₗ that is proportional to the sum of segment lengths for each of said segments, and where said segments are arrayed in an irregular compressed pattern,
said loops are nested together whereby the area of one of said loops is within an area enclosed by another of said loops.

2. (Original) The loop antenna of claim 1 wherein said first and second conductors of said connection means include first and second tangs, respectively.

3. (Original) The loop antenna of claim 2 wherein said first and second tangs exhibit the same spring compression for making balanced electrical connection to first and second pads at ends of one or more of said loops.

4. (Original) The loop antenna of claim 1 wherein said connection means includes two compressible metal tangs that have balanced spring compression for making electrical connection to said loops.

5. (Original) The loop antenna of claim 1 wherein each of said loops have first and second termination points where said first termination point for each of said loops connects in common at a first pad, where said second termination point for each of said loops connect in common at a second pad and where said first pad and second pad connect as part of said first and second conductors, respectively, for conduction of electrical current through said loops.

6. (Original) The loop antenna of claim 1 wherein said loops are on different layers separated by a dielectric.

7. (Original) The loop antenna of claim 1 wherein one or more of said radiation loops is on one layer mounted on a dielectric material and one or more other ones of said radiation loops is on a different layer mounted on said dielectric material.

8. (Original) The loop antenna of claim 1 wherein said loops are nested on the same layer supported by a dielectric substrate.

9. (Original) The loop antenna of claim 1 wherein ones of said segments are arrayed in multiple divergent directions not parallel to an orthogonal coordinate system so as to provide a predetermined antenna electrical length while enabling the said loop to fit within an established antenna area of said communication device.

10. (Original) The loop antenna of claim 1 wherein said radiation loop has an irregular shape and wherein said segments are arrayed in an irregular pattern.

11. (Original) The loop antenna of claim 1 wherein said segments are formed of conductive traces on a flexible dielectric substrate.

12. (Original) The loop antenna of claim 1 wherein said radiation loops transmit and receive radiation.

13. (Original) The loop antenna of claim 1 wherein one or more of said radiation loops transmit and receive in a US PCS band operating from 1850 MHz to 1990 MHz.

14. (Original) The loop antenna of claim 1 wherein one or more of said radiation loops transmit and receive in a European PCS band operating from 1710 MHz to 1880 MHz.

15. (Original) The loop antenna of claim 1 wherein one or more of said radiation loops transmit and receive in a European GSM band operating from 880 MHz to 960 MHz.

16. (Original) The loop antenna of claim 1 wherein said radiation loops transmit and receive in mobile telephone frequency bands operating anywhere from 800 MHz to 2400 MHz.

17. (Original) The loop antenna of claim 1 wherein a first one of said radiation loops is nested within a second one of said radiation loops and wherein said first one and said second one of said radiation loops are different in lengths by amounts that establish radiation frequencies that partially overlap and produce combined radiation frequencies for said first one and said second one of said radiation loops to establish a combined bandwidth greater than a bandwidth for either said first one and said second one of said radiation loops alone.

18. (Original) The loop antenna of claim 1 wherein one or more of said radiation loops is on one layer mounted on a dielectric material and one or more other ones of said radiation loops is on a different layer mounted on said dielectric material.

19. (Original) The loop antenna of claim 1 wherein a first one of said radiation loops is on one layer mounted on a dielectric material and where a conductive region is on a different layer mounted on said dielectric material juxtaposed said first one of said radiation loops.

20. (Original) The loop antenna of claim 1 wherein a first one of said radiation loops is nested within a second one of said radiation loops and wherein said first one and said second one of said radiation loops are different in lengths by amounts that establish radiation frequencies that partially overlap and produce combined radiation frequencies for said first one and said second one of said radiation loops to establish a combined bandwidth greater than a bandwidth for either said first one and said second one of said radiation loops alone.

21. (Original) The loop antenna of claim 1 wherein one or more first ones of said radiation loops and one or more said second ones of said radiation loops are different in length by amounts that establish radiation frequencies that do not substantially overlap and thereby produce combined radiation frequencies for said first ones and said second ones of said radiation loops to establish first and second bands of said frequencies that are separated and do not substantially overlap.

22. (Original) The loop antenna of claim 1 wherein a first one of said radiation loops is on one layer mounted on a dielectric material and where a conductive region is on a different layer mounted on said dielectric material juxtaposed said first one of said radiation loops whereby said a conductive region tunes said first one of said radiation loops.

23. (Original) The loop antenna of claim 1 wherein said loops provide multi-band performance.

24. (Original) The loop antenna of claim 1 wherein said bands of frequencies are not harmonically related.

25. (Original) The loop antenna of claim 1 wherein one or more first ones of said radiation loops is on a first layer mounted on a dielectric material and one or more second ones of said radiation loops is on a second layer mounted on said dielectric material, where said first ones of said loops have first and second first-layer termination points connected in common to first and second first-layer pads, respectively, on said first layer and where said second ones of said loops have first and second second-layer termination points connected in common to first and second second-layer pads, respectively, on said second layer.

26. (Original) The loop antenna of claim 25 wherein said first and second first-layer pads are juxtaposed said first and second second-layer pads, respectively, whereby said first ones of said radiation loops are electrically coupled to said second ones of said radiation loops.

27. (Original) The loop antenna of claim 1 wherein first, second and third ones of said radiation loops is on a first layer mounted on a dielectric material wherein said first one of said radiation loops is nested with an offset inside said first one of said radiation loops to establish first and second bands of said frequencies and wherein said third one of said radiation loops encloses said first and second radiation loops to establish a third band of said frequencies.

28. (Original) The loop antenna of claim 27 wherein third and fourth ones of said radiation loops is on a second layer mounted on said dielectric material wherein said third and fourth ones of said radiation loops are mirror images of and are juxtaposed said first and second ones of said radiation loops.

29. (Original) The loop antenna of claim 28 including a conductive region juxtaposed said third one of said radiation loops for tuning said third radiation loop.

30. (Original) The loop antenna of claim 1 wherein a plurality of said radiation loops have first and second termination points connected in common to first and second pads, respectively, where said first and second pads are the only electrical connections for said plurality of said radiation loops to a transceiver unit in said communication device.

31. (Original) The loop antenna of claim 30 wherein said first and second first-layer pads are juxtaposed said first and second second-layer pads, respectively, whereby said first ones of said radiation loops are electrically coupled to said second ones of said radiation loops.

32. (Original) The loop antenna of claim 1 wherein each of said loops performs with loop antenna operation to establish low SAR for said loop antenna.

33. (Original) A communication device operating for exchanging energy in bands of radiation frequencies, comprising,
a case for housing the communication device,
connection means for mounting internal to said case for conduction of electrical current,
a loop antenna formed of two or more radiation loops wherein,
each loop includes a plurality of electrically conducting segments, each segment having a segment length, where the segments are electrically connected in series to said connection means to form a loop antenna for exchange of energy in one of said bands of radiation frequencies, said loop having an electrical length, Aₗ that is proportional to the sum of the segment length for each of said segments, and where said segments are arrayed in a compressed pattern,
said loops are superimposed whereby an area enclosed by one of said loops covers an area enclosed by another of said loops.

34. (Original) The communication device of claim 33 wherein said loop antenna is installed inside said case.

35. (Original) The communication device of claim 34 wherein said communication device is a mobile telephone.

36. (Original) The communication device of claim 34 wherein said loop antenna is installed on said case with an adhesive.

37. (Original) The communication device of claim 34 wherein said loop antenna is molded into said case.
